(19) United States
(12) Patent Application Publication
(10) Pub. No.: US 2021/0131930 A1
(43) Pub. Date: May 6, 2021

(54) DAMAGE DETECTION APPARATUS, METHOD, AND PROGRAM

(71) Applicant: NEC Corporation, Tokyo (JP)

(72) Inventors: Shohei KINOSHITA, Tokyo (JP); Shigeru KASAI, Tokyo (JP); Yu KIYOKAWA, Tokyo (JP)

(73) Assignee: NEC Corporation, Minato-ku, Tokyo (JP)

(21) Appl. No.: 16/500,140

(22) PCT Filed: Apr. 7, 2017
(86) PCT No.: PCT/JP2017/014537

§ 371 Date: Oct. 2, 2019

(51) Int. Cl. G01N 3/06; G01N 3/56; G05D 19/02

(52) U.S. Cl. CPC G01N 3/062; G05D 19/02; G01N 3/56

(57) ABSTRACT

The present invention provides a damage detection apparatus, a damage detection method, and a damage detection program that can detect damage in a support by measuring vibration of a supported object. The damage detection apparatus that detects damage in a structure including a supported object and a support according to one example embodiment of the present invention includes a dominant frequency acquisition unit that acquires a dominant frequency from vibration information at a plurality of points on the supported object; a rigid body vibration identification unit that identifies rigid body vibration information on the structure from the acquired dominant frequency; and a damage determination unit that determines damage in the support based on the identified rigid body vibration information.

### TECHNICAL FIELD

The present invention relates to an apparatus, a method, and a program for detecting damage in a structure.

### BACKGROUND ART

Conventionally, damage (defect) inspection of a structure is performed by visual observation. In visual inspection, it takes time when a large structure is inspected, and damage that has occurred in a place that is not visible from the outside (such as inner portion, a complex part, or the like) may not be detected. Accordingly, to inspect a structure efficiently, a technology for detecting damage based on vibration of the structure has been developed.

Patent Literature 1 discloses a technology that measures vibration of a rail for a train by using a vibration sensor and, when a peak frequency (dominant frequency) of the vibration deviates from a predetermined tolerable range, determines that the rail is broken. According to the technology, the vibration sensor is provided directly on the rail to be measured.

Patent Literature 2 discloses that, in a structure to support a supported object by a support, vibration of the supported object is measured by an acceleration sensor, and a frequency having a large difference from a spectrum in a normal state is extracted. Then, in the technology, wavelet conversion is performed on the extracted frequency, and it is determined that there is occurrence of an anomaly when the temporal change in the intensity is small in the obtained scalogram.

### CITATION LIST

### Patent Literature

PTL 1: Japanese Patent Application Laid-Open No. 2012-158919

PTL 2: Japanese Patent Application Laid-Open No. 2016-50404

### SUMMARY OF INVENTION

In a structure constructed to support a supported object by a support, the support is often smaller than the supported object. Further, since a support is located under the supported object, the access thereto may be difficult. When the technology according to Patent Literature 1 is applied to such a structure, sensors need to be provided on both the support and the supported object. Therefore, the number of installed sensors increases, and the cost increases. Further, since a support is small and difficult to be accessed, it may be difficult to provide a sensor on the support.

Since the technology according to Patent Literature 2 collectively inspects vibration of a support and a supported object, it is not possible to determine which of the support or the supported object has damage. For example, while the technology according to Patent Literature 2 can detect that there is an air gap between the support and the supported object, it is not possible to know which of the support or the supported object has the cause of the air gap.

The present invention has been made in view of the problems described above and provides a damage detection apparatus, a damage detection method, and the damage detection program that can detect damage in a support by measuring vibration of a supported object.

A first example aspect of the present invention is a damage detection apparatus that detects damage in a structure including a supported object and a support that supports the supported object, and the damage detection apparatus includes: an acquisition unit that acquires a dominant frequency from vibration information at a plurality of points on the supported object; an identification unit that identifies rigid body vibration information on the structure from the acquired dominant frequency; and a determination unit that determines damage in the support based on the identified rigid body vibration information.

A second example aspect of the present invention is a damage detection method that detects damage in a structure including a supported object and a support that supports the supported object, and the damage detection method includes steps of: acquiring a dominant frequency from vibration information at a plurality of points on the supported object; identifying rigid body vibration information on the structure from the acquired dominant frequency; and determining damage in the support based on the identified rigid body vibration information.

A third example aspect of the present invention is a damage detection program that detects damage in a structure including a supported object and a support that supports the supported object, and the damage detection program causes a computer to perform steps of: acquiring a dominant frequency from vibration information at a plurality of points on the supported object; identifying rigid body vibration information on the structure from the acquired dominant frequency; and determining damage in the support based on the identified rigid body vibration information.

According to the present invention, since damage in a support is detected by measuring vibration of a supported object, no sensor needs to be provided on the support, and the number of sensors can be reduced. Further, even when it is difficult to provide a sensor directly on a support due to the shape of a structure, damage in the support can be detected.

### BRIEF DESCRIPTION OF DRAWINGS

FIG. 1 is a schematic diagram of a damage detection system according to a first example embodiment.

FIG. 2 is a block diagram of a damage detection apparatus according to the first example embodiment.

FIG. 3 is a schematic diagram of rigid body vibration according to the first example embodiment.

FIG. 4 is a diagram illustrating a graph of vibration information according to the first example embodiment.

FIG. 5 is a general configuration diagram illustrating an exemplary apparatus configuration of the damage detection apparatus according to the first example embodiment.

FIG. 6 is a diagram illustrating a flowchart of a damage detection method according to the first example embodiment.

FIG. 7 is a schematic diagram of a damage detection method according to an example.

FIG. 8 is a block diagram of a damage detection apparatus according to a second example embodiment.

FIG. 9 is a schematic diagram of a damage detection method according to the second example embodiment.

FIG. 10 is a diagram illustrating a flowchart of the damage detection method according to the second example embodiment.

FIG. 11 is a general configuration diagram of the damage detection apparatus according to each of the example embodiments.

### DESCRIPTION OF EMBODIMENTS

While example embodiments of the present invention will be described below with reference to the drawings, the present invention is not limited to these example embodiments. Note that components having the same function in the drawings described below are labelled with the same reference, and the repeated description the6 may be omitted.

### First Example Embodiment

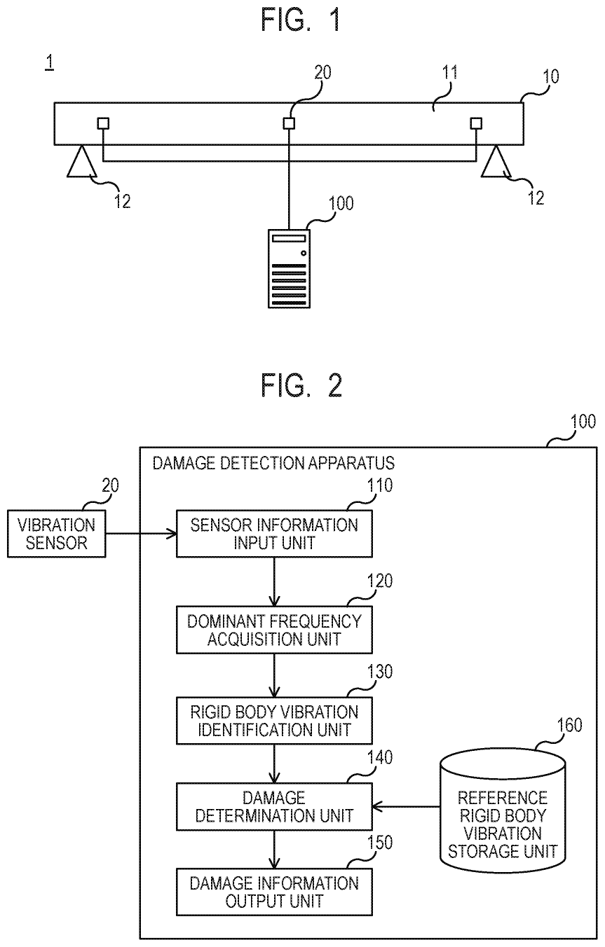

FIG. 1 is a schematic diagram of a damage detection system according to the present example embodiment. The damage detection system 1 has a vibration sensor 20 that measures vibration and a damage detection apparatus 100 that performs damage detection by using a measurement value measured by the vibration sensor 20. A structure 10 includes a supported object 11 and a support 12 that supports the supported object 11. The supported object 11 is a member having any shape such as a rod or a plate. The support 12 is a separate member from the supported object 11, which has any shape such as a cone or a cylinder and. The support 12 is in contact with the bottom side of the supported object 11 in the direction of gravity to support the supported object 11. In accordance with the shape and the size of the supported object 11, the supports 12 are provided in such the number and arrangement that can stably support the supported object 11. In the example of FIG. 1, for one rod-shaped supported object 11, respective supports 12 are provided near both ends of the supported object 11 in a one-to-one manner (two in total).

The vibration sensor 20 is a sensor that detects vibration by measuring at least one of a displacement, a speed, an acceleration of an object to be measured (the supported object 11). As the vibration sensor 20, any sensor such as a sensor using an electrostatic capacitance, a sensor using an overcurrent, a sensor using a Doppler effect, a sensor using a piezoelectric effect, or the like is used in accordance with the size or the characteristics of the object to be measured. The vibration sensor 20 measures vibration information on the supported object 11 and transmits the measured vibration information to the damage detection apparatus 100 as data. The vibration sensor 20 may be connected directly to the damage detection apparatus 100, may be connected by using wireless communication, or may be connected via a network.

The vibration sensor 20 is provided inside or on the surface of the supported object 11. In accordance with the shape and the size of the supported object 11, the sensors 20 are provided in such the number and arrangement that can measure vibration of the entire supported object 11. It is desirable that the vibration sensor 20 be provided near each of the supports 12 and in the middle of the two supports 12. In other words, the vibration sensor 20 in the middle of the two supports is provided at a position closer to the midpoint of a line segment connecting the two supports 12 than to the two supports 12. Further, the vibration sensors 12 near the respective supports 12 are provided at positions closer to the two supports than to the midpoint. With such a configuration, the vibration sensor 20 can acquire sufficient vibration information used for distinguishing rigid body vibration from elastic vibration and can identify the vibration mode of rigid body vibration at high accuracy in the process described below. In the example of FIG. 1, for one supported object 11, respective vibration sensors 20 are provided near and at the midpoint of the two supports 12 on the supported object 11 in a one-to one manner (three in total).

The damage detection apparatus 100 detects damage in the support 12 supporting the supported object 11 based on vibration information on the supported object 11 measured by the vibration sensor 20.

FIG. 2 is a block diagram of the damage detection apparatus 100 according to the present example embodiment. In FIG. 2, the arrows represent main dataflows, and there may be dataflows other than those illustrated in FIG. 2. In FIG. 2, each block illustrates a configuration in a unit of function rather than in a unit of hardware (apparatus). Therefore, the block illustrated in FIG. 2 may be implemented in a single apparatus or may be implemented independently in a plurality of apparatuses. Transfer of the data between blocks may be performed via any means, such as a data bus, a network, a portable storage medium, or the like.

The damage detection apparatus 100 has a sensor information input unit 110, a dominant frequency acquisition unit 120, a rigid body vibration identification unit 130, a damage determination unit 140, and a damage information output unit 150 as a processing unit. Further, the damage detection apparatus 100 has a reference rigid body vibration storage unit 160 as a storage unit.

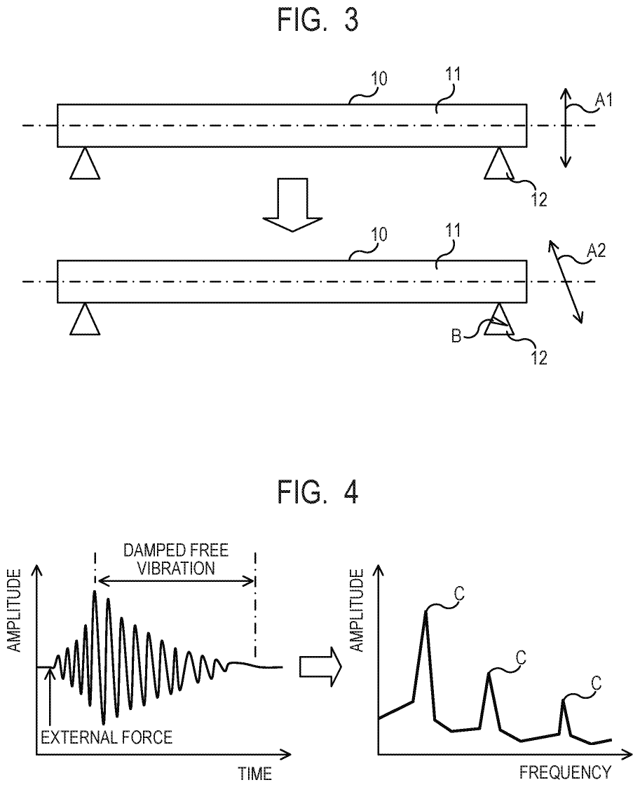

FIG. 3 is a schematic diagram of the rigid body vibration according to the present example embodiment. The vibration of the supported object 11 measured by the vibration sensor 20 is a mixture of rigid body vibration and elastic vibration. Rigid body vibration is vibration of the entire structure without deformation of the structure. On the other hand, elastic vibration is vibration generated inside the structure with deformation of the structure.

In a structure formed of the supported object 11 and the support 12 as in the present example embodiment, the characteristics of rigid body vibration depend on the mass of the supported object 11 and the rigidity of the support 12. The characteristics of rigid body vibration are a dominant frequency in a vibration mode, a damping ratio, and a vibration shape (that is, a phase and an amplitude). Therefore, when the mass of the supported object 11 is constant, a change in the rigidity of the support 12 (that is, an occurrence of damage in the support 12) can be known from the characteristics of rigid body vibration.

As illustrated in the upper diagram in FIG. 3, when no damage B occurs in the support 12 (that is, in normal state), rigid body vibration of a characteristic A1 occurs in the supported object 11. As illustrated in the lower diagram in FIG. 3, when the damage B occurs in the support 12, rigid body vibration of a characteristic A2 that is different from the characteristic A1 in a normal state occurs in the supported object 11. The damage B is a crack, a shift, an adherence, or the like that may occur in the support 12 and affects the rigidity of the support 12. While the rigid vibration characteristics A1 and A2 are represented by the arrows in FIG. 3 for better visibility, the rigid vibration characteristics A1 and A2 are practically a dominant frequency, a damping ratio, and a vibration shape.

The damage detection apparatus 100 identifies rigid body vibration information from vibration information on the supported object 11 measured at a plurality of points of the supported object 11 (that is, measured by a plurality of vibration sensors 20) and determines the presence or absence of damage in the support 12 that supports the supported object 11 based on the identified rigid body vibration information.

The sensor information input unit 110 receives data of vibration information from a plurality of vibration sensors 20, respectively, and input the received data to the damage detection apparatus 100. At this time, the sensor information input unit 110 may perform predetermined conversion on data of vibration information such that the data of vibration information from the vibration sensors 20 can be used by the damage detection apparatus 100.

FIG. 4 is a diagram illustrating graphs of vibration information according to the present example embodiment. The left diagram in FIG. 4 is a graph illustrating a temporal change of vibration of the supported object 11 measured by the vibration sensor 20, where the horizontal axis represents time (arbitrary unit) and the vertical axis represents amplitude (arbitrary unit). In the left diagram in FIG. 4, the time when application of external force to the supported object 11 is started is indicated by the arrow. When application of external force to the supported object 11 starts at a certain moment and external force is then removed and no longer works, the amplitude of vibration first increases and then gradually attenuates. Such vibration that attenuates without external force is referred to as damped free vibration.

The dominant frequency acquisition unit 120 generates a wave pattern of a temporal change of vibration from vibration information input by the sensor information input unit 110. The dominant frequency acquisition unit 120 then acquires a range of damped free vibration in the wave pattern of the time change of vibration, performs Fourier transformation on the range of damped free vibration, and thereby generates a frequency distribution of respective frequency components included in the damped free vibration. The vibration frequency distribution is generated for each of the plurality of vibration sensors 20. The range of damped free vibration in the wave pattern of the temporal change of vibration may be identified from a wave pattern by the dominant frequency acquisition unit 120 or may be specified by a user. As a method of Fourier transformation, any well-known method may be used.

The right diagram in FIG. 4 is a graph illustrating a vibration frequency distribution, where the horizontal axis represents time (arbitrary unit) and the vertical axis represents amplitude (arbitrary unit). In the vibration frequency distribution, a peak at which the amplitude has the local maximum appears. The dominant frequency acquisition unit 120 acquires a frequency having the peak in the vibration frequency distribution as one or more dominant frequencies C (also referred to as a peak frequency(s)). At this time, the dominant frequency acquisition unit 120 may acquire a predetermined number (at least one) of the dominant frequencies C in descending order of the amplitude. Alternatively, the dominant frequency acquisition unit 120 may acquire at least one dominant frequency C having amplitude that is higher than or equal to a predetermined threshold. The number of acquired dominant frequencies C and the threshold of amplitude used as the reference are set in accordance with the size and the shape of the supported object 11. The dominant frequency C is acquired for each of the plurality of vibration sensors 20.

The rigid body vibration identification unit 130 identifies a frequency of rigid body vibration out of the dominant frequencies C acquired by the dominant frequency acquisition unit 120. As a first method, the rigid body vibration identification unit 130 identifies the frequency of rigid body vibration based on the variation of the vibration shape (that is, the phase and the amplitude) in each of the dominant frequencies C between multiple points. In a vibration mode of rigid body vibration without deformation of the supported object 11, the variation of the phase and the amplitude at the multiple points on the supported object 11 is small. Therefore, the rigid body vibration identification unit 130 estimates the dominant frequency C having small variation in the phase and the amplitude as the frequency of rigid body vibration.

Specifically, first, the rigid body vibration identification unit 130 acquires phase and amplitude in each dominant frequency C from the plurality of vibration sensors 20. Next, the rigid body vibration identification unit 130 calculates variation of the phase and variation of the amplitude between the plurality of vibration sensors 20 (that is, the multiple points on the supported object 11) with respect to each of the dominant frequencies C. As variation in the phase and the amplitude, any statistical quantity that can represent the variation degree of a value, such as a dispersion, a standard deviation, or the like, can be used. Finally, the rigid body vibration identification unit 130 identifies the dominant frequency C at which the variation of the phase and the amplitude satisfies a predetermined condition as the frequency of rigid body vibration. The condition for the variation of the phase and the amplitude is that the variation of the phase is lower than (or lower than or equal to) a predetermined value, and the variation of the amplitude is lower than (or lower than or equal to) a predetermined value, for example. When a plurality of dominant frequencies C satisfy the predetermined condition, the dominant frequency C having the smallest variation of the phase and the amplitude may be identified as the frequency of rigid body vibration.

As a second method, the rigid body vibration identification unit 130 identifies the frequency of rigid body vibration by comparing the vibration shape (that is, the phase and the amplitude) at the dominant frequency C with a predetermined vibration shape of rigid body vibration. The vibration mode of rigid body vibration can be defined by performing an experiment or a simulation in advance. Accordingly, the correlation between the measured vibration mode and the predetermined variation mode of rigid body vibration is calculated for each of the dominant frequencies C. The rigid body vibration identification unit 130 estimates the dominant frequency C of the vibration mode having a high correlation with the predetermined rigid body vibration as the frequency of rigid body vibration.

Specifically, Modal Assurance Criterion (MAC) is used in order to estimate the correlation between the modes. The rigid body vibration identification unit 130 calculates a correlation value (MAC value) for each of the dominant frequencies C by using Equation (1) below.

$$\begin{matrix}[ Math . 1 ] & \\ MAC ( F , I ) - \frac{{〈 {ϕ}^{F} \vert {ϕ}^{I} 〉}^{2}}{〈 {ϕ}^{F} \vert {ϕ}^{F} 〉 〈 {ϕ}^{I} \vert {ϕ}^{I} 〉} & ( 1 )\end{matrix}$$

A label symbol I denotes a predetermined reference value of rigid body vibration, and a label symbol F denotes a measurement value in one dominant frequency C. A label symbol ϕ is a vibration shape vector, which is expressed by Equation (2) below.

[Math. 2]

|ϕ^{I} [symbol] =^{t}(r₁^{I}e^{iθ}^{₁}^{^{I}}, r₂^{I}e^{iθ}^{₂}^{^{I}}, . . . rₙ^{I}e^{iθ}^{ₙ}^{^{I}})

|ϕ^{F} [symbol] =^{t}(r₁^{F}e^{iθ}^{₁}^{^{F}}, r₂^{F}e^{iθ}^{₂}^{^{F}}, . . . rₙ^{F}e^{iθ}^{ₙ}^{^{F}}) (2)

A symbol n denotes each of the points on the supported object 11 (each of the plurality of vibration sensors 20), a symbol r denotes an amplitude, and a symbol θ denotes a phase.

With respect to the correlation value (MAC value), a larger value (closer to 1) indicates a higher correlation between the two modes. The rigid body vibration identification unit 130 identifies a dominant frequency C in which the correlation value satisfies a predetermined condition as the frequency of rigid body vibration. The condition of the correlation value is that the correlation value is larger than (or larger than or equal to) a predetermined value, for example. When a plurality of dominant frequencies C satisfy the predetermined condition, the dominant frequency C having the largest correlation value may be identified as the frequency of rigid body vibration.

Further, the rigid body vibration identification unit 130 identifies the dominant frequency C identified as the frequency of rigid body vibration and the vibration shape at the dominant frequency C (that is, the phase and the amplitude) as rigid body vibration information. The dominant frequency C, the phase, and the amplitude of rigid body vibration information may be acquired from the average value of measurement values of a plurality of vibration sensors 20. Further, the dominant frequency C of rigid body vibration information may be acquired from any measurement value of a plurality of vibration sensors 20. For identification of rigid body vibration performed by the rigid body vibration identification unit 130, without being limited to the first method and the second method described above, any method that can determine whether or not the dominant frequency C is the frequency of rigid body vibration may be used.

The damage determination unit 140 determines the presence or absence of damage in the support 12 that supports the supported object 11 based on rigid body vibration information (the dominant frequency C, the phase, and the amplitude) identified by the rigid body vibration identification unit 130. Specifically, first, rigid body vibration information (the dominant frequency C, the phase, and the amplitude) is acquired in advance by the rigid body vibration identification unit 130 in the past reference period and stored in the reference rigid body vibration storage unit 160 as reference rigid body vibration information. The reference period is a period in which it can be considered that no damage has occurred in the structure 10, such as the time of the initial state of the structure 10, for example.

The damage determination unit 140 receives rigid body vibration information acquired by the rigid body vibration identification unit 130 when damage detection is performed and also reads reference rigid body vibration information from the reference rigid body vibration storage unit 160. Next, the damage determination unit 140 calculates the degree of change in rigid body vibration information with respect to reference rigid body vibration information. In the present example embodiment, as the degree of change in rigid body vibration information, the change rate of the dominant frequency C of rigid body vibration, the change rate of the phase at the dominant frequency C, and the change rate of the amplitude at the dominant frequency C are used. As the degree of change in rigid body vibration information, in addition to the change rate, any index that can represent the degree of change in rigid body vibration information, such as the amount of a change in the dominant frequency C, the phase, and the amplitude, the Euclidean distance before and after the change, or the like can be used.

The damage determination unit 140 determines that there is damage in the support 12 when the degree of change in rigid body vibration information from reference rigid body vibration information satisfies a predetermined condition. The condition of the degree of change is that at least one of the dominant frequency C, the phase, and the amplitude has a change rate larger than (or larger than or equal to) a predetermined value, for example.

The damage information output unit 150 outputs information indicating the presence or absence of damage in the support 12 determined by the damage determination unit 140 by using any method such as display by using a display, paper printing by a printer, data storage in a storage device, or the like.

As described above, the damage detection apparatus 100 according to the present example embodiment identifies rigid body vibration information from vibration information measured by the vibration sensors 20 at a plurality of points on the supported object 11 and detects damage in the support 12 supporting the supported object 11 based on the identified rigid body vibration information. Therefore, it is not necessary to provide the vibration sensor 20 on the support 12.

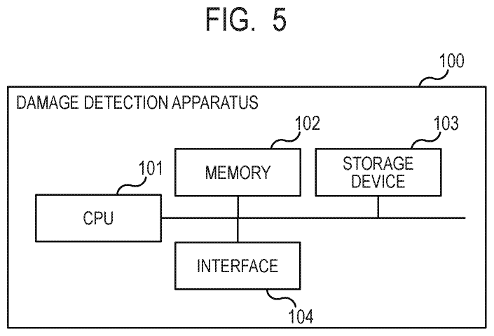

FIG. 5 is a general configuration diagram illustrating an exemplary apparatus configuration of the damage detection apparatus 100 according to the present example embodiment. The damage detection apparatus 100 has a central processing unit (CPU) 101, a memory 102, a storage device 103, and an interface 104. The damage detection apparatus 100 may be a standalone apparatus or configured integrally with another apparatus.

The interface 104 is a communication unit that transmits and receives data and is configured to be able to perform at least one of the communication schemes of wired communication and wireless communication. The interface 104 includes a processor, an electric circuit, an antenna, a connection terminal, or the like required for the above communication scheme. The interface 104 performs communication using the communication scheme in accordance with signals from the CPU 101. The interface 104 performs communication with the vibration sensor 20, for example.

The storage device 103 stores a program executed by the damage detection apparatus 100, data of a process result obtained by the program, or the like. The storage device 103 includes a read only memory (ROM) dedicated to reading, a hard disk drive or a flash memory that is readable and writable, or the like. Further, the storage device 103 may include a computer readable portable storage medium such as a CD-ROM.

The memory 102 includes a random access memory (RAM) or the like that temporarily stores data being processed by the CPU 101 or a program and data read from the storage device 103.

The CPU 101 is a processor that temporarily stores temporary data used for processing in the memory 102, reads a program stored in the storage device 103, and performs various processing operations such as calculation, control, determination, or the like on the temporary data in accordance with the program. Further, the CPU 101 stores data of a process result in the storage device 103 and also transmits data of the process result externally via the interface 104.

In the present example embodiment, the CPU 101 functions as the sensor information input unit 110, the dominant frequency acquisition unit 120, the rigid body vibration identification unit 130, the damage detection unit 140, and the damage information output unit 150 of FIG. 2 by executing a program stored in the storage device 103. Further, the memory 102 or the storage device 103 function as the reference rigid body vibration storage unit 160.

The damage detection apparatus 100 is not limited to the specific configuration illustrated in FIG. 5. The damage detection apparatus 100 is not limited to a single apparatus and may be configured such that two or more physically separated apparatuses are connected by wired or wireless connection. Each component included in the damage detection apparatus 100 may be implemented by an electric circuitry, respectively. The electric circuitry here is a term conceptually including a single apparatus, multiple apparatuses, a chipset, or a cloud.

Further, at least a part of the damage detection apparatus 100 may be provided in a form of Software as a Service (SaaS). That is, at least some of the functions for implementing the damage detection apparatus 100 may be performed by software executed via a network.

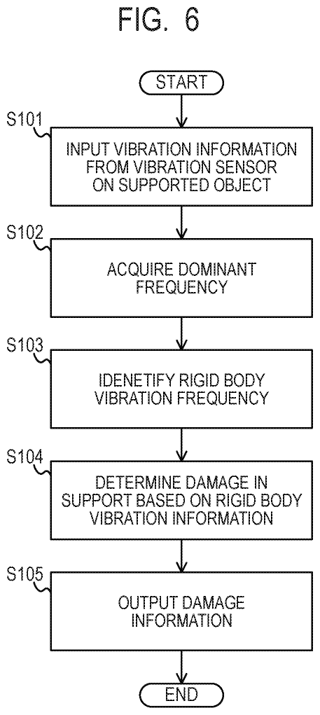

FIG. 6 is a diagram illustrating a flowchart of a damage detection method according to the present example embodiment. The flowchart of FIG. 6 is started when a user inputs a predetermined instruction to the damage detection apparatus 100, for example.

First, the sensor information input unit 110 receives data of vibration information from each of the plurality of vibration sensors 20 and inputs the data in the damage detection apparatus 100 (step S101). The dominant frequency acquisition unit 120 generates a vibration frequency distribution from vibration information input in the step 5101 and acquires a frequency having a peak in the frequency distribution of the dominant frequency C (step S102).

The rigid body vibration identification unit 130 identifies the frequency of rigid body vibration from the dominant frequency C acquired in step S102 (step S103). To identify the frequency of rigid body vibration, the variation of the vibration shape on the supported object 11 may be used as in the first method described above, or the correlation with the predetermined vibration shape of rigid body vibration may be used as in the second method described above.

The damage determination unit 140 determines the presence or absence of damage in the support 12 supporting the supported object 11 based on rigid body vibration information (the dominant frequency C, the phase, and the amplitude) of rigid body vibration identified in step S103 (step S104). Finally, the damage information output unit 150 outputs information indicating the presence or absence of damage in the support 12 determined in step S104 by any method (step S105).

The CPU 101 of the damage detection apparatus 100 serves as the entity of each step (process) included in the damage detection method illustrated in FIG. 6. That is, the CPU 101 reads a damage detection program used for performing the damage detection method illustrated in FIG. 6 from the memory 102 or the storage device 103 and performs the damage detection method illustrated in FIG. 6 by executing the program and controlling each unit of the damage detection apparatus 100.

By using the damage detection apparatus 100 according to the present example embodiment, since the presence or absence of damage in the support 12 can be determined based on vibration information measured by the vibration sensor 20 provided on the supported object 11 in the structure 10, it is not necessary to provide the vibration sensor 20 on the support 12. Therefore, even when the support 12 is hidden by the supported object 11 and it is difficult to provide the vibration sensor 20 on the support 12, damage in the support 12 can be detected. Further, the number of the vibration sensors 20 required for detecting damage in the structure 10 can be reduced.

### EXAMPLE

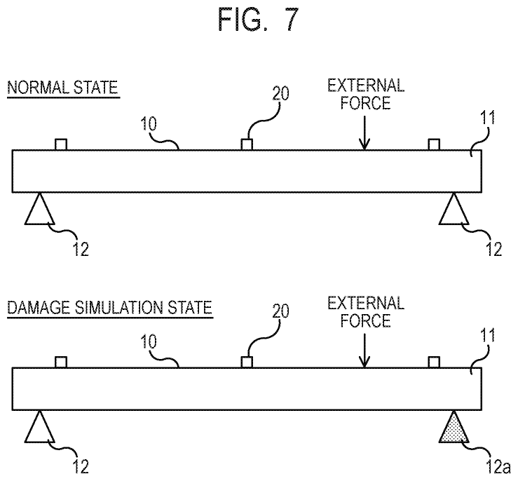

An experiment of the damage detection method according to the first example embodiment was performed. FIG. 7 is a schematic diagram of the damage detection method according to the present example. As illustrated in FIG. 7, the structure 10 in a normal state and the structure 10 in a damage simulation state were prepared. In the normal state, the supported object 11 was supported by the support 12, and in the damage simulation state, the supported object 11 was supported by the support 12 and a support 12a having rigidity different from that of the support 12. The support 12a having different rigidity simulates the support 12 in which damage occurs. A plurality of vibration sensors 20 were provided on the surface of the supported object 11. Note that, in the actual experiment, after measurement on the structure 10 in the normal state was performed, measurement on the structure 10 in the damage simulation state was performed by replacing the support 12 with the support 12a.

External force was applied by a hummer to the structure 10 in the normal state and the structure 10 in the damage simulation state, respectively. Then, in accordance with the damage detection method of the first example embodiment, the dominant frequencies were acquired from vibration information measured by the vibration sensors 20, and the dominant frequency of the rigid body vibration was identified from the acquired dominant frequencies.

As a result, the dominant frequency of the rigid body vibration measured in the structure 10 in the normal state was 80 Hz, and the dominant frequency of the rigid body vibration measured in the structure 10 in the damage simulation state was 70 Hz. That is, the change rate of the dominant frequency in the damage simulation state with reference to the dominant frequency in the normal state is −14%. In such a way, when the rigidity of the support 12 changes (that is, damage occurs in the support 12), since the rigid body vibration information changes, it was confirmed that the presence or absence of damage can be determined based on rigid body information.

### Second Example Embodiment

In the first example embodiment, the presence or absence of damage in the support is determined. In addition, in the present example embodiment, it is estimated where damage is located, that is, which support has the damage.

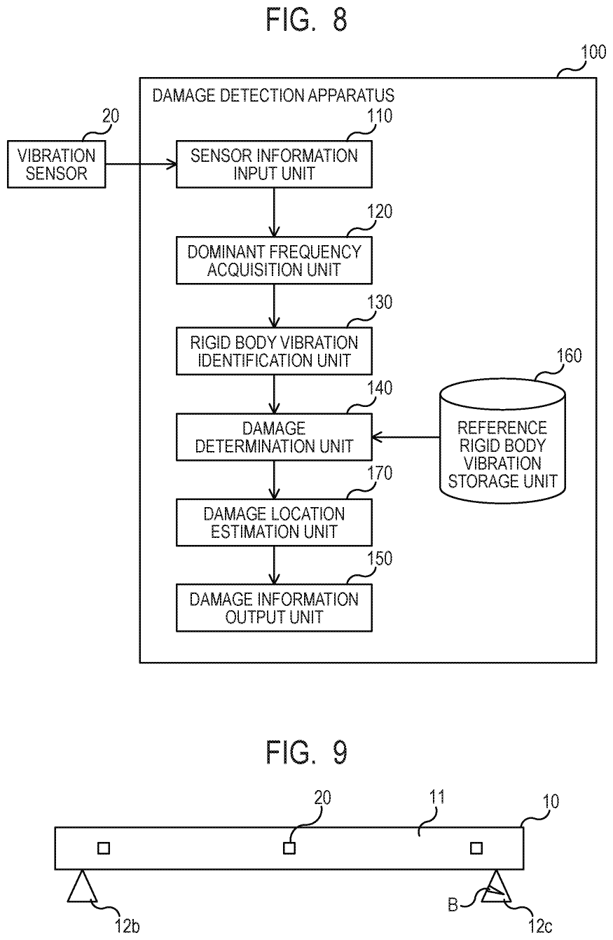

FIG. 8 is a block diagram of the damage detection apparatus 100 according to the present example embodiment. In FIG. 8, the arrows represent main dataflows, and there may be dataflows other than those illustrated in FIG. 8. In FIG. 8, each block illustrates a configuration in a unit of function rather than in a unit of hardware (apparatus). Therefore, the block illustrated in FIG. 8 may be implemented in a single apparatus or may be implemented independently in a plurality of apparatuses. Transfer of the data between blocks may be performed via any means, such as a data bus, a network, a portable storage medium, or the like.

The damage detection apparatus 100 according to the present example embodiment has a damage location estimation unit 170 in addition to the configuration of FIG. 2. The damage location estimation unit 170 estimates which support 12 has the damage by comparing pieces of rigid body vibration information on respective points (that is, respective vibration sensors 20) of the supported object 11.

FIG. 9 is a schematic diagram of the damage detection method according to the present example embodiment. It is here assumed that the supported object 11 is supported by the support 12b without damage B and the support 12c with damage B in the structure 10. In the same method as in the first example embodiment, the damage detection apparatus 100 acquires the dominant frequencies from vibration information measured by the vibration sensors 20, identifies rigid body vibration information from the acquired dominant frequencies, and determines the presence or absence of damage based on the identified rigid body vibration information.

When the damage determination unit 140 determines that there is damage, the damage location estimation unit 170 compares pieces of rigid body vibration information (the dominant frequency, the phase, and the amplitude) at a plurality of points (that is, the plurality of vibration sensors 20) on the supported object 11 with each other. In the example of FIG. 9, a measurement value of the vibration sensor 20 closest to the support 12c with damage B is different from measurement values of the other vibration sensors 20. Therefore, by comparing pieces of rigid body vibration information between the plurality of vibration sensors 20, it is possible to determine the vibration sensor 20 close to the support 12c with the damage B.

For comparison of rigid body vibration information, the damage location estimation unit 170 calculates the degree of similarity of rigid body vibration information (the dominant frequency, the phase, and the amplitude) of one vibration sensor to the average of rigid body vibration information of the other vibration sensors 20. In the present example embodiment, as the degree of similarity of rigid body vibration information, the change rate of the dominant frequency C of rigid body vibration, the change rate of the phase at the dominant frequency C, and the change rate of the amplitude at the dominant frequency C are used. As the degree of similarity of rigid body vibration information, in addition to the change rate, any index that can represent the degree of similarity of rigid body vibration information, such as the amount of a change in the dominant frequency C, the phase, and the amplitude, the Euclidean distance relative to the average value, or the like can be used.

Next, the damage location estimation unit 170 selects a vibration sensor 20 having rigid body vibration information in which the change rate with respect to the average value in rigid body vibration information of other vibration sensors 20 is larger than (or larger than or equal to) a predetermined threshold. Alternatively, the damage location estimation unit 170 may select the vibration sensor 20 which has rigid body vibration information having the largest change rate relative to the average value in rigid body vibration information of other vibration sensors 20. Finally, the damage location estimation unit 170 estimates that damage B is located on the support 12 (support 12c) closest to the selected vibration sensor 20.

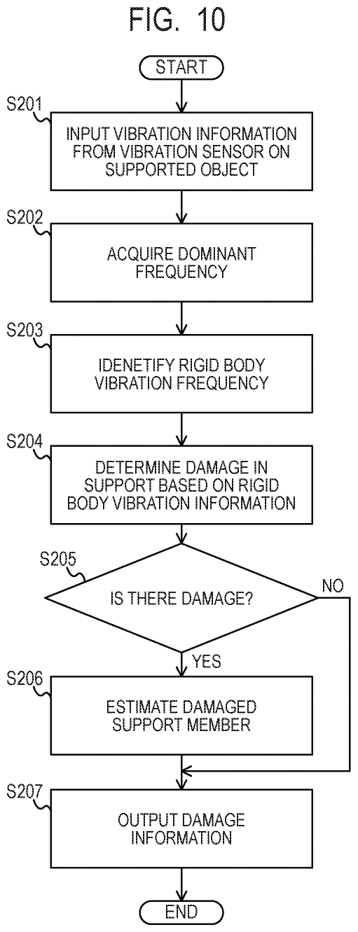

FIG. 10 is a diagram illustrating a flowchart of the damage detection method according to the present example embodiment. The flowchart of FIG. 10 is started when a user inputs a predetermined instruction to the damage detection apparatus 100, for example.

Steps S201 to S204 are the same as steps S101 to S104 of FIG. 6.

If it is determined in step S204 that there is no damage (step S205, NO), the process proceeds to step S207. If it is determined in step S204 that there is damage (step S205, YES), by comparing pieces of rigid body vibration information (the dominant frequency, the phase, and the amplitude) of the plurality of vibration sensors 20 with each other, the damage location estimation unit 170 selects the vibration sensor 20 having rigid body vibration information different from rigid body vibration information of other vibration sensors 20. Then the damage location estimation unit 170 estimates that there is damage in the support 12 closest to the selected vibration sensor 20 (step S206).

Finally, the damage information output unit 150 outputs information indicating the presence or absence of damage in the support 12 determined in step S204 and information indicating the damaged support 12 estimated in step S206 in any method (step S207).

The CPU 101 of the damage detection apparatus 100 serves as the entity of each step (process) included in the damage detection method illustrated in FIG. 10. That is, the CPU 101 reads a damage detection program used for performing the damage detection method illustrated in FIG. 10 from the memory 102 or the storage device 103 and performs the damage detection method illustrated in FIG. 10 by executing the program and controlling each unit of the damage detection apparatus 100.

According to the damage detection apparatus 100 according to the present example embodiment, the same effect as the first example embodiment can be obtained, and it is also possible to estimate which support 12 has damage.

### Other Example Embodiments

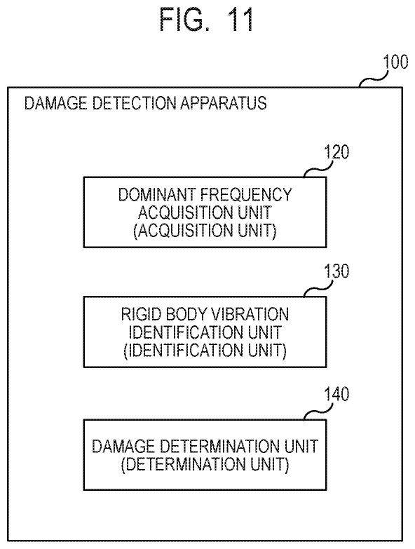

FIG. 11 is a general configuration diagram of the damage detection apparatus 100 according to each of the example embodiments described above. FIG. 11 illustrates a configuration example in which the damage detection apparatus 100 functions as an apparatus that can detect damage in a support by measuring vibration of a supported object. To detect damage in a structure including a supported object and a support that supports the supported object, the damage detection apparatus 100 has a dominant frequency acquisition unit 120 (acquisition unit) that acquires one or more dominant frequencies from vibration information at a plurality of points of the supported object, a rigid body vibration identification unit 130 (identification unit) that identifies rigid body vibration information on the structure from the acquired one or more dominant frequencies, and a damage determination unit 140 (determination unit) that determines damage in the support based on the identified rigid body vibration information.

The present invention can be applied to any structure such as a bridge having a structure in which a bridge girder is supported by bearings on an abutment, for example. The present invention is not limited to the example embodiments described above and can be properly changed within the scope not departing from the spirit of the present invention.

The scope of each of the example embodiments further includes a processing method that stores, in a storage medium, a program that causes the configuration of each of the example embodiments to operate so as to implement the function of each of the example embodiments described above (more specifically, a damage detection program that causes a computer to perform the process illustrated in FIG. 6 and FIG. 10), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary note 1)

A damage detection apparatus that detects damage in a structure including a supported object and at least one support that supports the supported object, the damage detection apparatus comprising:

an acquisition unit that acquires a dominant frequency from vibration information at a plurality of points on the supported object;

an identification unit that identifies rigid body vibration information on the structure from the acquired dominant frequency; and

a determination unit that determines damage in the support based on the identified rigid body vibration information.

(Supplementary note 2)

The damage detection apparatus according to supplementary note 1, wherein the identification unit identifies the rigid body vibration information based on variation of phases and amplitudes at the dominant frequency at the plurality of points.

(Supplementary note 3)

The damage detection apparatus according to supplementary note 1, wherein the identification unit identifies the rigid body vibration information by comparing phases and amplitudes at the dominant frequency at the plurality of points with a phase and an amplitude of the rigid body vibration that has been predetermined.

(Supplementary note 4)

The damage detection apparatus according to any one of supplementary notes 1 to 3, wherein the rigid body vibration information includes the dominant frequency, a phase at the dominant frequency, and an amplitude at the dominant frequency.

(Supplementary note 5)

The damage detection apparatus according to any one of supplementary notes 1 to 4, wherein the determination unit determines the damage by comparing the identified rigid body vibration information with the rigid body vibration information acquired in a past reference period in the structure.

(Supplementary note 6)

The damage detection apparatus according to supplementary note 5, wherein the determination unit determines the damage based on a degree of change in the identified rigid body vibration information relative to the rigid body vibration information acquired in the reference period in the structure.

(Supplementary note 7)

The damage detection apparatus according to supplementary note 6, wherein the determination unit determines the damage based on a degree of change in the dominant frequency included in the identified rigid body vibration information relative to the dominant frequency included in the rigid body vibration information acquired in the reference period in the structure.

(Supplementary note 8)

The damage detection apparatus according to any one of supplementary notes 1 to 7, wherein the acquisition unit acquires the dominant frequency based on damped free vibration included in the vibration.

(Supplementary note 9)

The damage detection apparatus according to supplementary note 8, wherein the acquisition unit acquires the dominant frequency based on a magnitude of an amplitude of each frequency component included in the damped free vibration.

(Supplementary note 10)

The damage detection apparatus according to any one of supplementary notes 1 to 9,

wherein the structure includes a plurality of supports, and

wherein the damage detection apparatus further comprises an estimation unit that estimates which of the plurality of supports has the damage by comparing pieces of information on the rigid body vibration at the plurality of points with each other.

(Supplementary note 11)

A damage detection method that detects damage in a structure including a supported object and a support that supports the supported object, the damage detection method comprising steps of:

acquiring a dominant frequency from vibration information at a plurality of points on the supported object;

identifying rigid body vibration information on the structure from the acquired dominant frequency; and

determining damage in the support based on the identified rigid body vibration information.

(Supplementary note 12)

A damage detection program that detects damage in a structure including a supported object and a support that supports the supported object, the damage detection program causing a computer to perform steps of:

acquiring a dominant frequency from vibration information at a plurality of points on the supported object;

identifying rigid body vibration information on the structure from the acquired dominant frequency; and

determining damage in the support based on the identified rigid body vibration information.

What is claimed is:

1. A damage detection apparatus that detects damage in a structure including a supported object and at least one support that supports the supported object, the damage detection apparatus comprising:
an acquisition unit that acquires a dominant frequency from vibration information at a plurality of points on the supported object;
an identification unit that identifies rigid body vibration information on the structure from the acquired dominant frequency; and
a determination unit that determines damage in the support based on the identified rigid body vibration information.

2. The damage detection apparatus according to claim 1, wherein the identification unit identifies the rigid body vibration information based on variation of phases and amplitudes at the dominant frequency at the plurality of points.

3. The damage detection apparatus according to claim 1, wherein the identification unit identifies the rigid body vibration information by comparing phases and amplitudes at the dominant frequency at the plurality of points with a phase and an amplitude of the rigid body vibration that has been predetermined.

4. The damage detection apparatus according to claim 1, wherein the rigid body vibration information includes the dominant frequency, a phase at the dominant frequency, and an amplitude at the dominant frequency.

5. The damage detection apparatus according to claim 1, wherein the determination unit determines the damage by comparing the identified rigid body vibration information with the rigid body vibration information acquired in a past reference period in the structure.

6. The damage detection apparatus according to claim 5, wherein the determination unit determines the damage based on a degree of change in the identified rigid body vibration information relative to the rigid body vibration information acquired in the reference period in the structure.

7. The damage detection apparatus according to claim 6, wherein the determination unit determines the damage based on a degree of change in the dominant frequency included in the identified rigid body vibration information relative to the dominant frequency included in the rigid body vibration information acquired in the reference period in the structure.

8. The damage detection apparatus according to claim 1, wherein the acquisition unit acquires the dominant frequency based on damped free vibration included in the vibration.

9. The damage detection apparatus according to claim 8, wherein the acquisition unit acquires the dominant frequency based on a magnitude of an amplitude of each frequency component included in the damped free vibration.

10. The damage detection apparatus according to claim 1,
wherein the structure includes a plurality of supports, and
wherein the damage detection apparatus further comprises an estimation unit that estimates which of the plurality of supports has the damage by comparing pieces of information on the rigid body vibration at the plurality of points with each other.

11. A damage detection method that detects damage in a structure including a supported object and a support that supports the supported object, the damage detection method comprising steps of:
acquiring a dominant frequency from vibration information at a plurality of points on the supported object;
identifying rigid body vibration information on the structure from the acquired dominant frequency; and
determining damage in the support based on the identified rigid body vibration information.

12. A non-transitory storage medium storing a damage detection program that detects damage in a structure including a supported object and a support that supports the supported object, the damage detection program causing a computer to perform steps of:
acquiring a dominant frequency from vibration information at a plurality of points on the supported object;
identifying rigid body vibration information on the structure from the acquired dominant frequency; and
determining damage in the support based on the identified rigid body vibration information.
